(19) United States
(12) Patent Application Publication
(10) Pub. No.: US 2011/0163703 A1
(43) Pub. Date: Jul. 7, 2011

(54) Direct Current Brushless Motor Capable Of Generating Electric Power

(75) Inventor: Chii-Maw Uang, Kaohsiung City (TW)

(73) Assignee: Teng-san Tseng, Wufong Township (TW)

(21) Appl. No.: 12/684,105

(22) Filed: Jan. 7, 2010

(51) Int. Cl. H02P 27/00

(52) U.S. Cl. 318/400.3

(57) ABSTRACT

A direct current brushless motor capable of generating electric power includes a winding controlled by a control circuit for producing a rotating magnetic field and coupled by a neutral point, a neutral point switching circuit for controlling conduction and cut-off states between the neutral point and the winding, such that an undriven phase and the neutral point are cut off, and a recycle circuit, having a charging switch for actuating the corresponding neutral point switching circuit, and the recycle circuit is actuated according to a switching sequence of the neutral point switching circuit, such that a counter electromotive force produced by an undriven phase of the direct current brushless motor is recharged into a battery.

### BACKGROUND OF THE INVENTION

(a) Field of the Invention

The present invention relates to a direct current brushless motor, and more particularly to a direct current brushless motor capable of generating electric power.

(b) Description of the Related Art

Direct current brushless motor is a high-performance motor, since its performance is much higher than that of a conventional motor, and a direct current brushless motor uses an electronic circuit to generate sequential pulses to drive an electromagnet to produce a rotating magnetic field and drive the motor, and this the direct current brushless motor can reduce worn-out and performance loss effectively. Unlike a brush motor that requires changing a carbon brush and reducing metal bits and sparks produced by the friction of the carbon brush. Since the rotation of the motor will produce a counter electromotive force, therefore some manufacturers make use of the counter electromotive force to recycle electric power through a recycle circuit, and the recycled electric power is processed by a boost circuit and then used for recharging a battery, so as to achieve both motion and electric generation effects.

However, the counter electromotive force produced during the operation of a general direct current brushless motor is consumed or lost easily in each phase change during the operation of the motor, such that the actual available output power is very limited. Thus, it is a main subject of the present invention to find a way of improving the electric power generation efficiency of the counter electromotive force of the direct current brushless motor effectively, and the inventor of the present invention based on years of experience in the related industry to conduct extensive researches and experiments, and finally developed a direct current brushless motor capable of generating electric power in accordance with the present invention to overcome the shortcomings of the prior art.

### SUMMARY OF THE INVENTION

Therefore, it is a primary objective of the present invention to overcome the aforementioned shortcoming and deficiency of the prior art by providing a direct current brushless motor capable of generating electric power and improving the electric power generation efficiency of the direct current brushless motor by utilizing counter electromotive forces.

To achieve the aforementioned objective, the present invention provides a direct current brushless motor capable of generating electric power, comprising:

a winding, controlled by a control circuit for sequentially performing a two phases conducting strategy and producing a rotating magnetic field, and the winding being coupled by a neutral point;

a neutral point switching circuit, for controlling conduction and cut-off states between the neutral point and the winding, such that the winding is cut off from the neutral point at an undriven phase in the two phases conducting strategy; and

a recycle circuit, including a charging switch for actuating the corresponding neutral point switching circuit, and the charging switch being actuated according to a sequence of switching the neutral point switching circuit that recycles a counter electromotive force of the direct current brushless motor at an undriven phase in the two phases conducting strategy to recharge back into a battery.

### BRIEF DESCRIPTION OF THE DRAWINGS

FIG. 1 is a schematic view of a structure of the present invention;

FIG. 2 is a schematic view of an application of the present invention, showing that the present invention is situated at a condition when AT_BB is in an ON state;

FIG. 3 is a schematic view of an application of the present invention, showing that the present invention is situated at a condition when BT_AB is in an ON state;

FIG. 4 is a schematic view of an application of the present invention, showing that the present invention is situated at a condition when CT_AB is in an ON state;

FIG. 5 is a schematic view of an application of the present invention, showing that the present invention is situated at a condition when CT_BB is in an ON state;

FIG. 6 is a schematic view of an application of the present invention, showing that the present invention is situated at a condition when AT_CB is in an ON state; and

FIG. 7 is a schematic view of an application of the present invention, showing that the present invention is situated at a condition when BT_CB is in an ON state.

### DETAILED DESCRIPTION OF THE PREFERRED EMBODIMENTS

The technical characteristics of the present invention will become apparent with the detailed description of the preferred embodiments and the illustration of the related drawings as follows.

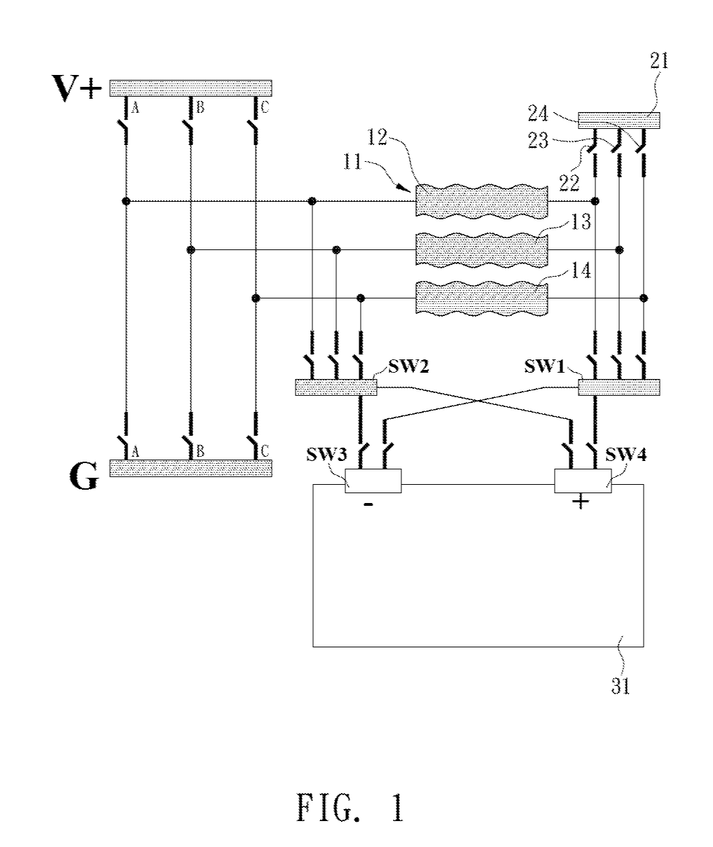

With reference to FIG. 1 for a direct current brushless motor capable of generating electric power in accordance with the present invention, the direct current brushless motor comprises a winding 11, a neutral point switching circuit and a recycle circuit.

The winding 11 is composed of three phases coils 12, 13, 14, and the winding 11 produces a rotating magnetic field by a control circuit once every time when two phases coils generate a phase conduction current by the two phases conducting strategy, and the winding 11 is coupled by a neutral point 21.

The neutral point switching circuit is comprised of a phase A switch 22, a phase B switch 23 and a phase C switch 24 installed between each phases coil 12, 13, 14 of the winding 11 and the neutral point 21, and each phase switch 22, 23, 24 is provided for controlling conduction and cut-off states between the neutral point 21 and the winding 11, and the neutral point switching circuit is provided for achieving the current steering effect, such that the winding 11 is cut off from the neutral point 21 at an undriven phase in the two phases conducting strategy, such that the counter electromotive force produced by the undriven phase will not return to the direct current brushless motor.

The recycle circuit includes four charging switches SW1, SW2, SW3, SW4, and each charging switch SW1, SW2, SW3, SW4 is actuated according to the switching sequence of the neutral point switching circuit, such that the counter electromotive force produced by the direct current brushless motor at an undriven phase in the two phases conducting strategy can be recharged into a battery 31 by a boost loop formed among each charging switch SW1, SW2, SW3, SW4 of the recycle circuit.

The actual actuation of the present invention includes the following actuation modes:

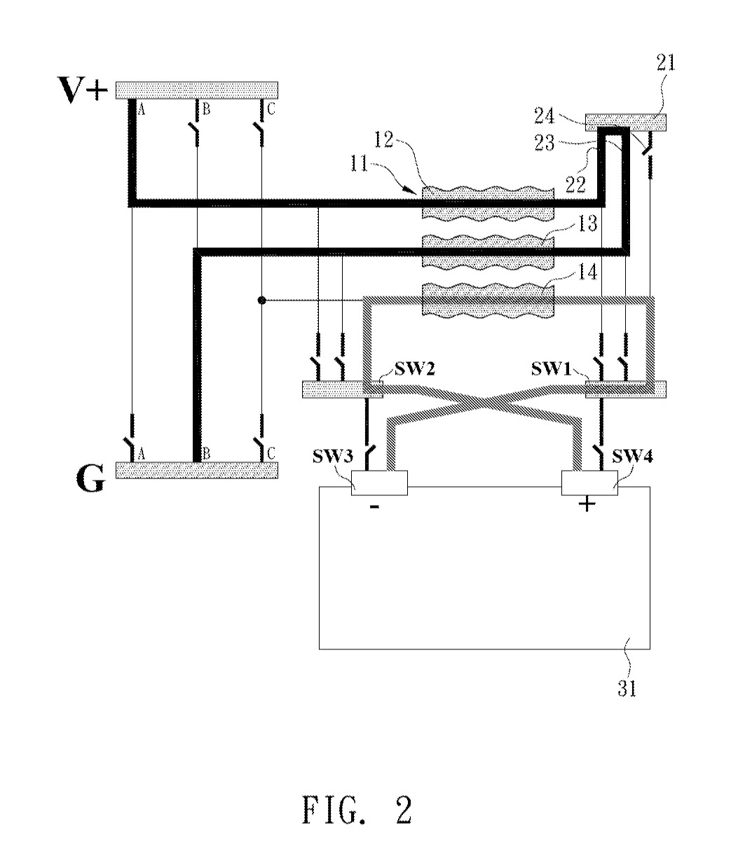

In FIG. 2, if the direct current brushless motor is situated at a condition when AT_BB is conducted, the neutral point switching circuit will turn on the phase A switch 22 and the phase B switch 23 into an ON state, and the charging switch SW1 and the charging switch SW2 in the recycle circuit will be actuated and switched to an open circuit cut-off state. Now, the undriven phase C constitutes a short circuit (or ON) state at the charging switch SW1 and the charging switch SW2. Before the phase C switch 24 is turned on, the charging switch SW1 and the charging switch SW2 are turned on according to a chosen direction from an output line to an input line, and the charging switch SW3 and the charging switch SW4 are switched correspondingly, such that a counter electromotive force produced by an undriven phase C is recharged into the battery 31 through a boost loop formed in the recycle circuit.

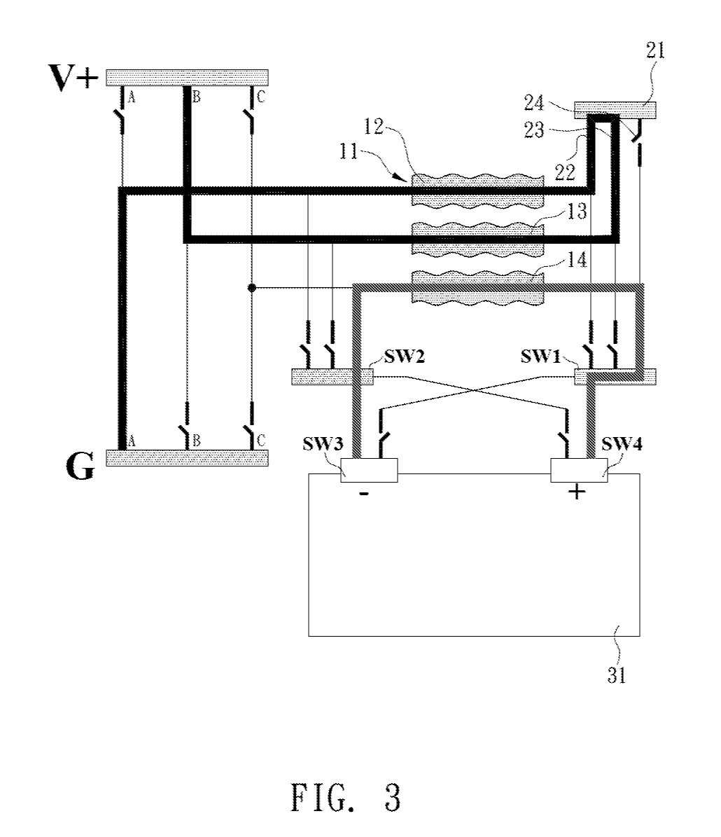

In FIG. 3, if the direct current brushless motor is situated at a condition when BT_AB is conducted, the neutral point switching circuit will turn on the phase A switch 22 and the phase B switch 23 into an ON state, and the charging switch SW1 and the charging switch SW2 in the recycle circuit will be actuated and switched to an open circuit cut-off state. Now, the undriven phase C constitutes a short circuit (or ON) state at the charging switch SW1 and the charging switch SW2. Before the phase C switch 24 is turned on, the charging switch SW1 and the charging switch SW2 are turned on according to a chosen direction from an input line to an output line, and the charging switch SW3 and the charging switch SW4 are switched correspondingly, such that a counter electromotive force produced by an undriven phase C is recharged into the battery 31 through a boost loop formed in the recycle circuit.

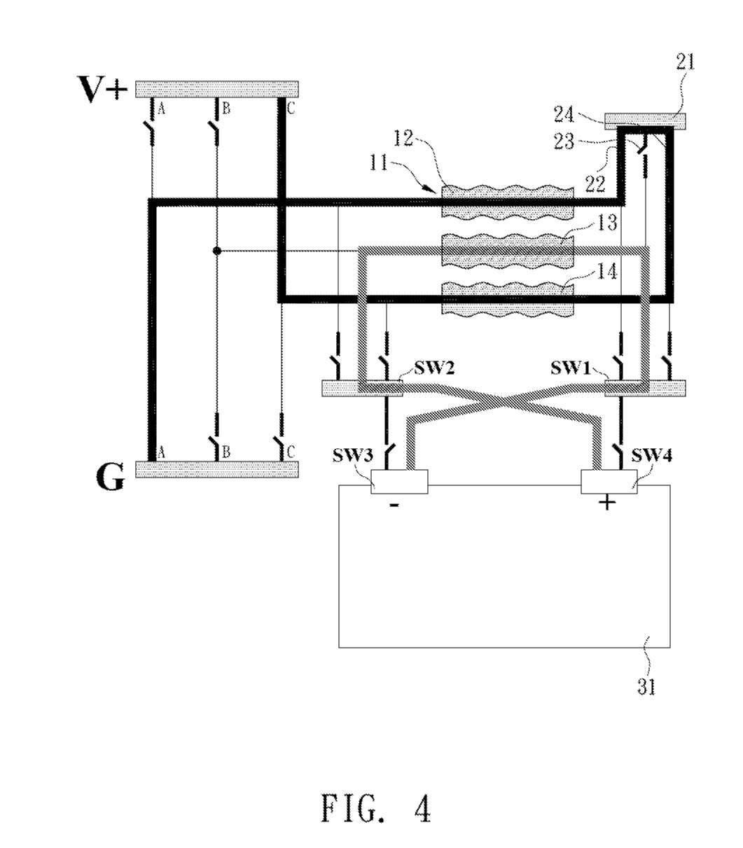

In FIG. 4, if the direct current brushless motor is situated at a condition when CT_AB is conducted, the neutral point switching circuit will turn on the phase A switch 22 and the phase B switch 23 into an ON state, and the charging switch SW1 and the charging switch SW2 in the recycle circuit will be actuated and switched to an open circuit cut-off state. Now, the undriven phase B constitutes a short circuit (or ON) state at the charging switch SW1 and the charging switch SW2. Before the phase B switch 23 is turned on, the charging switch SW1 and the charging switch SW2 are turned on according to a chosen direction from an output line to an input line, and the charging switch SW3 and the charging switch SW4 are switched correspondingly, such that a counter electromotive force produced by an undriven phase B is recharged into the battery 31 through a boost loop formed in the recycle circuit.

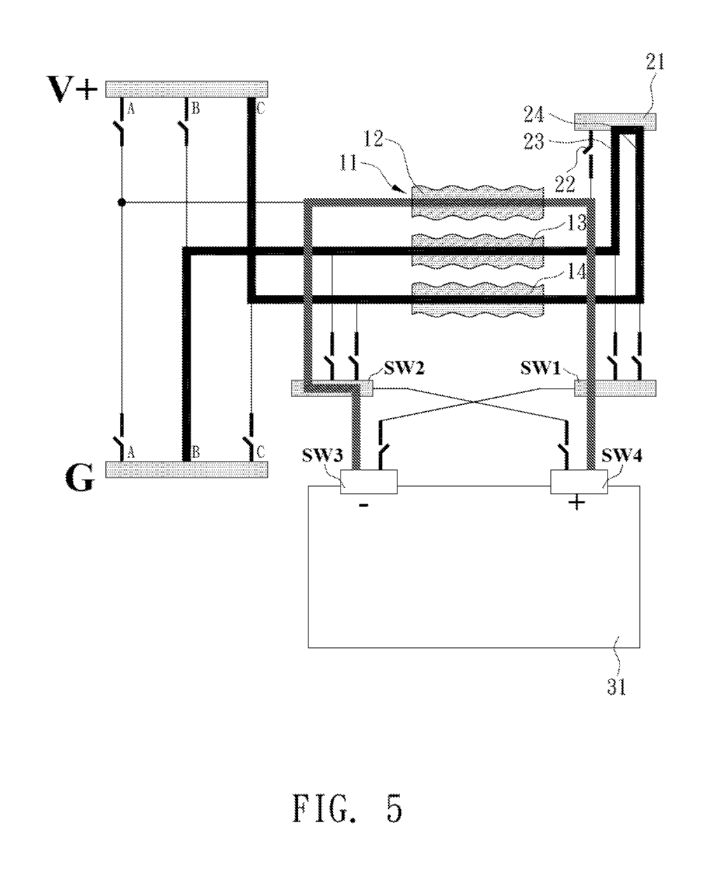

In FIG. 5, if the direct current brushless motor is situated at a condition when CT_BB is conducted, the neutral point switching circuit will turn on the phase B switch 23 and the phase C switch 24 into an ON state, and the charging switch SW1 and the charging switch SW2 in the recycle circuit will be actuated and switched to an open circuit cut-off state. Now, the undriven phase A constitutes a short circuit (or ON) state at the charging switch SW1 and the charging switch SW2. Before the phase A switch 22 is turned on, the charging switch SW1 and the charging switch SW2 are turned on according to a chosen direction from an input line to an output line, and the charging switch SW3 and the charging switch SW4 are switched correspondingly, such that a counter electromotive force produced by an undriven phase A is recharged into the battery 31 through a boost loop formed in the recycle circuit.

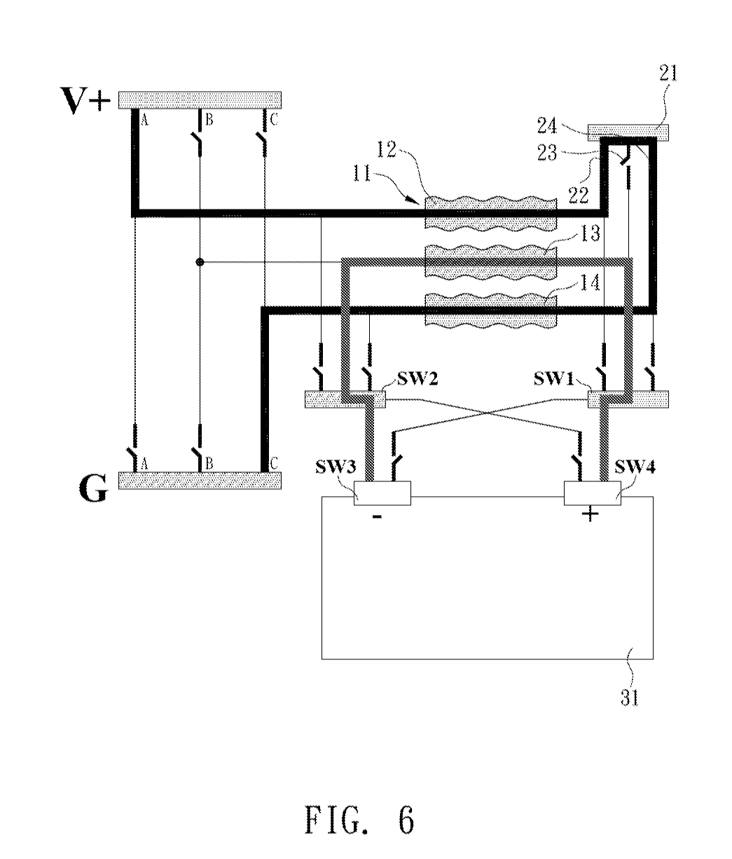

In FIG. 6, if the direct current brushless motor is situated at a condition when AT_CB is conducted, the neutral point switching circuit will turn on the phase A switch 22 and the phase C switch 24 into an ON state, and the charging switch SW1 and the charging switch SW2 in the recycle circuit will be actuated and switched to an open circuit cut-off state. Now, the undriven phase B constitutes a short circuit (or ON) state at the charging switch SW1 and the charging switch SW2. Before the phase B switch 23 is turned on, the charging switch SW1 and the charging switch SW2 are turned on according to a chosen direction from an input line to an output line, and the charging switch SW3 and the charging switch SW4 are switched correspondingly, such that a counter electromotive force produced by an undriven phase B is recharged into the battery 31 through a boost loop formed in the recycle circuit.

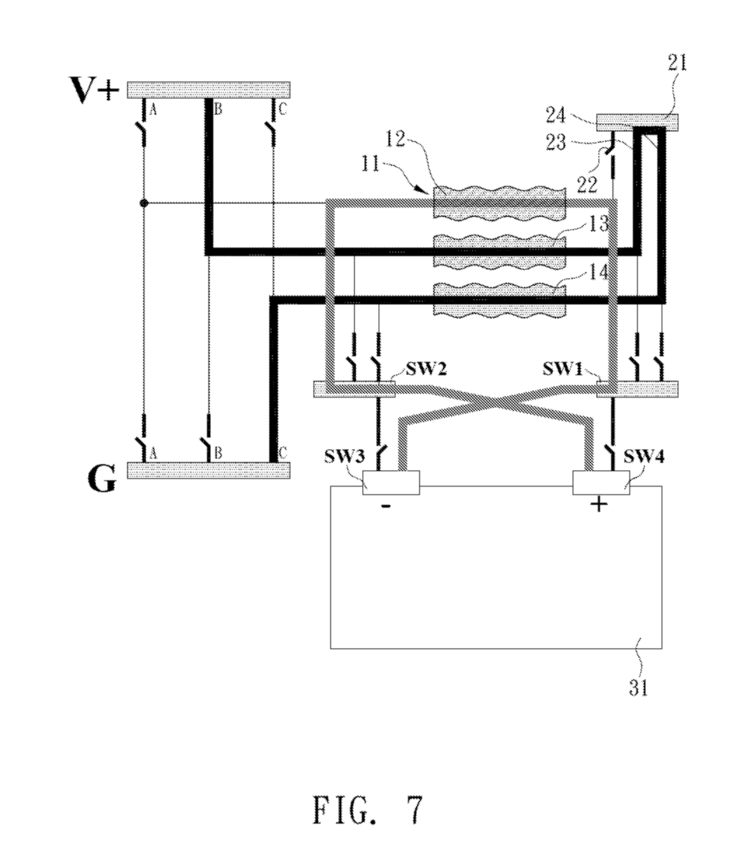

In FIG. 7, if the direct current brushless motor is situated at a condition when BT_CB is conducted, the neutral point switching circuit will turn on the phase B switch 23 and the phase C switch 24 and into an ON state, and the charging switch SW1 and the charging switch SW2 in the recycle circuit will be actuated and switched to an open circuit cut-off state. Now, the undriven phase A constitutes a short circuit (or ON) state at the charging switch SW1 and the charging switch SW2. Before the phase A switch 22 is turned on, the charging switch SW1 and the charging switch SW2 are turned on according to a chosen direction from an input line to an output line, and the charging switch SW3 and the charging switch SW4 are switched correspondingly, such that a counter electromotive force produced by an undriven phase A is recharged into the battery 31 through a boost loop formed in the recycle circuit.

It is noteworthy to point out that the present invention recharges the battery 31 by the boost loop formed in the recycle circuit and also drives the light emitting element (such as an LED lamp) or another electronic component.

In the present invention, the neutral points are used for the connection during the operation of the direct current brushless motor, and there is always a phase not driven by a six-step square wave in the two phases conducting strategy, and the present invention achieves the current steering function by using the neutral point switching circuit, and operates together with the charging switch in the recycle circuit for the corresponding actuation to obtain a counter electromotive force produced by an undriven phase, and the neutral point switching circuit is provided for the conduction and cutoff of the neutral point to assure that the current loop of the charging coil will not return to the direct current brushless motor, so as to reduce the loss of counter electromotive force and enhance the electric power efficiency of the counter electromotive force of the direct current brushless motor.

In summation of the description above, the present invention complies with the patent application requirements, and thus the invention is duly filed for patent application.

While the invention has been described by device of specific embodiments, numerous modifications and variations could be made thereto by those generally skilled in the art without departing from the scope and spirit of the invention set forth in the claims.

I claim:

1. A direct current brushless motor capable of generating electric power, comprising:
a winding, controlled by a control circuit, for sequentially performing a two phases conducting strategy and generating a rotating magnetic field, and the winding being coupled by a neutral point;
a neutral point switching circuit, for controlling conduction and cut-off states between the neutral point and the winding, and cutting off the winding from the neutral point at an undriven phase in the two phases conducting strategy;
a recycle circuit, having a charging switch for actuating the neutral point switching circuit, and the charging switch being actuated according to a switching sequence of the neutral point switching circuit, such that a counter electromotive force produced by an undriven phase of the direct current brushless motor in the two phases conducting strategy is recharged into a battery.

2. The direct current brushless motor capable of generating electric power as recited in claim 1, wherein the winding is comprised of three phases coils, and the winding generates a rotating magnetic field by a phase conduction current generated by the control circuit at every time of conducting two phases coils the in the two phases conducting strategy, and the neutral point switching circuit is comprised of a phase A switch, a phase B switch and a phase C switch installed respectively between the coils of the winding and the neutral point, and each phase switch is provided for controlling conduction and cut-off states between the neutral point and the winding, for preventing a counter electromotive force produced by an undriven phase from returning into the direct current brushless motor.

3. The direct current brushless motor capable of generating electric power as recited in claim 1, wherein if the direct current brushless motor performs a two phases conducting strategy, the neutral point switching circuit will drive the two conducted phases and the neutral point into an ON state, and the charging switch in the recycle circuit is actuated correspondingly to an open circuit cut-off state, and an undriven phase constitutes a short circuit (or ON) state at the charging switch, and before the undriven phase is turned on, the charging switch is turned on according to a chosen direction from an output line to an input line, and the charging switch is switched accordingly to recharge a counter electromotive force produced by the undriven phase back into the battery through the boost loop in the recycle circuit.

4. The direct current brushless motor capable of generating electric power as recited in claim 1, wherein the boost loop formed by the recycle circuit is provided for driving a light emitting element or an electronic component.
